(19) United States
(12) Patent Application Publication
(10) Pub. No.: US 2013/0154773 A1
(43) Pub. Date: Jun. 20, 2013

(54) Waveguide

(71) Applicant: Domagoj Siprak, Munich (DE)

(72) Inventor: Domagoj Siprak, Munich (DE)

(73) Assignee: Infineon Technologies AG, Neubiberg (DE)

(21) Appl. No.: 13/327,318

(22) Filed: Dec. 15, 2011

(51) Int. Cl. H01P 3/08

(52) U.S. Cl. 333/238

(57) ABSTRACT

A waveguide comprises an inner conductor arranged in a first layer, a pair of outer conductors comprising a first outer conductor and a second outer conductor, and a pair of slotted shields comprising a first slotted shield and a second slotted shield. The first slotted shield and the second slotted shield are arranged in a second layer with a spacing in between to form a section of a ground shield, wherein the second layer is parallel to the first layer. The first slotted shield is connected to the first outer conductor and the second slotted shield is connected to the second outer conductor.

### TECHNICAL FIELD

Embodiments of the invention relate to a waveguide, a quarter wavelength transformer, a waveguide for a differential signal, a directional coupler, a transmission line and method for transmitting a high frequency signal.

### BACKGROUND

A waveguide, for example, implemented within a chip and formed on a substrate may be used as a transmission line. A transmission line may be considered as a specialized cable design typically used for carrying high frequency signals, for example, signals of a mobile communication device. A common application of a transmission line is a connection between the radio frequency transceiver of a mobile communication device and its antenna. Here, the cable design is typically specialized because the frequency of the high frequency signal is high enough so that its wave nature must be taken into account.

The background thereof is that the transmission of a high frequency signal may cause phase delay, interferences or reflections on the line when the voltage of the high frequency signal changes in a time interval, which is comparable to the time the high frequency signal travels from the one end of the cable to the other end. In general, a cable should be designed as a transmission line if the length of the cable is greater than 1/20 of the wavelength in the respective dielectric material of the high frequency signal. In such cases a cable with a specialized construction or a so called slow wave transmission line may be used, wherein the construction is typically defined by precise conductor dimensions, precise spacings, and precise impedance matching. A typical example of a transmission line is a coaxial cable or a waveguide. A further application of a waveguide is a so-called quarter wavelength impedance transformer or a balun, which may be used for performing the conversion from a single ended signal to a differential signal.

### SUMMARY OF THE INVENTION

Embodiments of the invention provide a waveguide which comprises an inner conductor arranged in a first layer, a pair of outer conductors comprising a first outer conductor and a second outer conductor, and a pair of slotted shields comprising a first slotted shield and a second slotted shield. The first and second slotted shields are arranged in a second layer with a spacing in between to form a section of a ground shield, wherein the second layer is parallel to the first layer. Furthermore, the first slotted shield is connected to the first outer conductor and the second slotted shield is connected to the second outer conductor.

A further embodiment provides a waveguide which comprises an inner conductor arranged in a first layer and extending along a main extension, a pair of outer conductors comprising a first outer conductor and a second outer conductor, and a pair of slotted shields comprising a first slotted shield and a second slotted shield. Here, a boundary of the first outer conductor is parallel to a boundary of the inner conductor adjacent to the first outer conductor, and a boundary of the second outer conductor is parallel to a boundary of the inner conductor adjacent to the second outer conductor. The first slotted shield and the second slotted shield are arranged in a second layer with a spacing in between to form a section of a ground shield, wherein the second layer is parallel to the first layer, and wherein the spacing may be in a range between 10 nm up to a value smaller (e.g. by 100 nm or 200 nm or 500 nm or 1 um) than the spacing of the first and second outer conductors or in a range between 0.1 and 5.0 times the width of the inner conductor but smaller (e.g. by 100 nm or 200 nm or 500 nm or 1 um) than the spacing of the first and second outer conductors. The first slotted shield is electrically connected to the first outer conductor, and the second slotted shield is electrically connected to the second outer conductor. The first and second slotted shields comprise a plurality of slots arranged in the second layer, which slots are perpendicular to the main extension within a tolerance of +/−10 degrees.

A further embodiment provides a quarter wavelength transformer which comprises an inner conductor arranged in a first layer, a pair of outer conductors comprising a first outer conductor and a second outer conductor, and a pair of slotted shields comprising a first slotted shield and a second slotted shield. The first and second slotted shields are arranged in a second layer with a space in between to form a section of a ground shield, wherein the second layer is parallel to the first layer. The first slotted shield is connected to the first outer conductor and the second slotted shield is connected to the second outer conductor.

A further embodiment provides a method for transmitting a high frequency signal by use of a waveguide. The method comprises the step of exciting an electromagnetic wave in a waveguide, which comprises an inner conductor, a pair of outer conductors, a pair of slotted shields with a spacing in between and a medium within the waveguide. The step of exciting the electromagnetic wave is performed such that a phase velocity or group velocity of the electromagnetic wave in the waveguide is smaller, at least by a factor of 5/4, than a phase velocity or a group velocity of the electromagnetic wave in the medium.

### BRIEF DESCRIPTION OF THE DRAWINGS

Embodiments of the present invention will be explained below in more detail with reference to the figures, wherein:

FIGS. 1a to 1c show a conventional waveguide;

FIGS. 2a to 2d show a waveguide according to an embodiment;

FIGS. 3a to 3f show further waveguides according to further embodiments;

FIGS. 4a to 4c show further waveguides having more than one signal line according to further embodiments; and

FIG. 5 shows a diagram of the signal attenuation caused by a waveguide line for illustrating the quality improvement of the embodiments.

### DETAILED DESCRIPTION OF ILLUSTRATIVE EMBODIMENTS

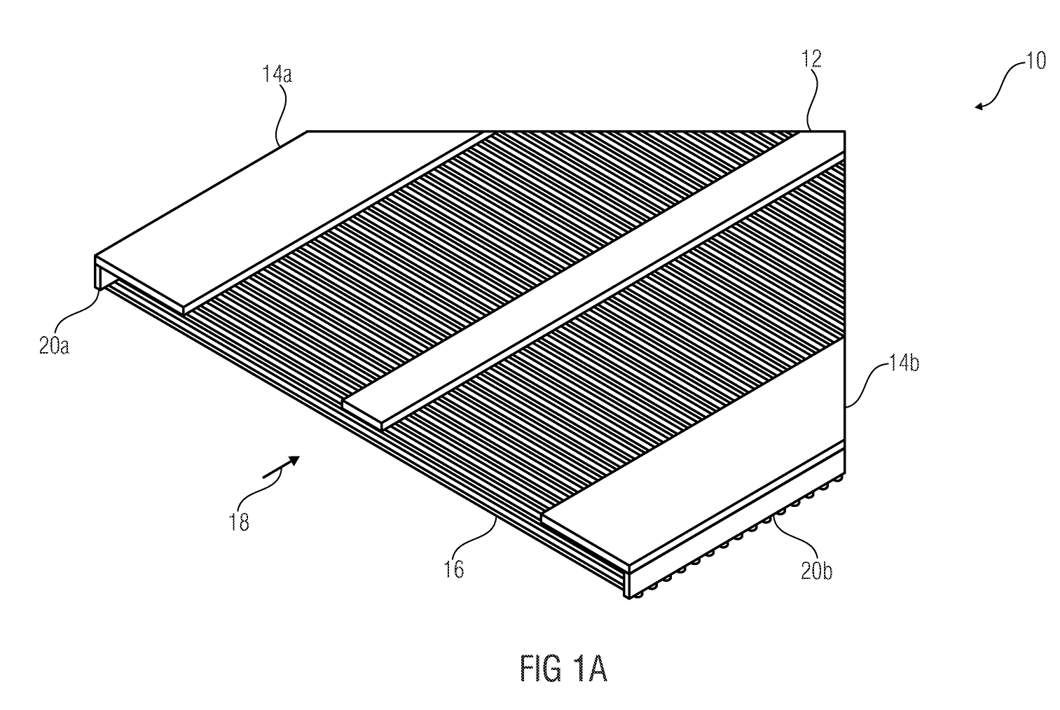

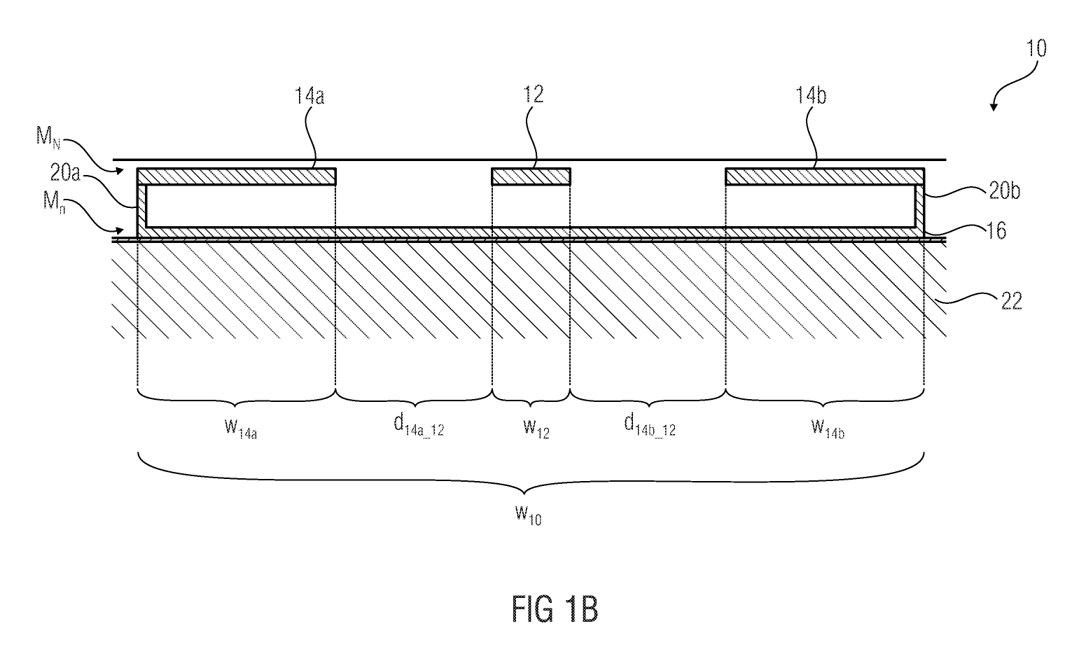

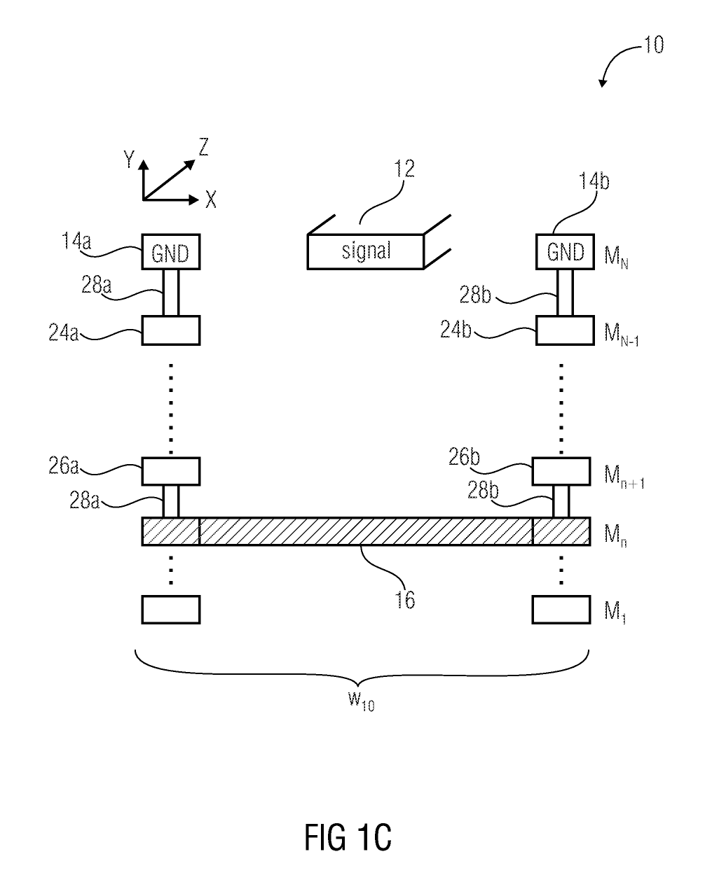

Different embodiments of the present invention will subsequently be discussed referring to FIG. 1 to FIG. 5. In advance, identical reference numerals are provided to objects having identical or similar functions so that objects referred to by identical reference numerals within the different embodiments are interchangeable and the description thereof is mutually applicable.

In the following some terms used in this application are described. A transmission line comprises conductors for transmitting the actual signal and providing connection to the ground potential of a circuit. A conductor in this case is typically a metal, like e.g. copper, aluminum, tungsten or combination of stacked metal or an alloy or silicide or the material where a gate of an MOS transistor is formed but is not limited to it, as any material that has an equal or higher conductivity than above mentioned materials can be used. The conductivity of a metal does in general depend on the thickness of the metal layer and the width of the metal line. In general, the conductivity decreases with decreasing thickness due to a reduced mobility of charge carriers in the metal due to boundary scattering mechanisms. Especially in modern CMOS technologies the metal layers near to the substrate have a small thickness that leads to a decrease in the conductivity of the metal. The conductivity of metals is usually measured in units of Siemens per meter [S/m]. In general the resistance of a conductor line in a transmission line is an increasing function with frequency due to the skin effect that limits the current flow to a only a part of the conductor.

The conductors of the transmission line can be separated by an isolating material, i.e. a dielectric material, as e.g. silicon dioxide, glass, low-k dielectrics, which is defined by its dielectric constant (or equivalently the k-factor) and the so called loss tangent that accounts for dielectric losses of the dielectric material.

Small pieces of floating metals, i.e. filling structures, can be embedded in the isolating dielectric material.

The transmission line is usually built upon a substrate. This substrate can be a semiconductor material, like e.g. silicon or any compound semiconductor material like gallium arsenide (GaAs). The substrate is usually characterized/defined by a dielectric constant and a resistivity given in Ohms times centimeter [Ω*cm] which describes its loss. The substrate may comprise layers of different semiconductor materials including also isolating dielectric materials like for e.g. the substrate of a silicon on insulator (SOI) technology.

The substrate can be doped with impurities, i.e. dopants that may change the substrate resistivity, or areas of the substrate are blocked from such dopants to have a higher substrate resistivity. Transmission lines build upon low resistivity substrates as used typically in CMOS technologies suffer from lossy Eddy currents which are induced by the magnetic fields generated by the currents in the conductors of the transmission line or lossy currents that are induced via electric fields in the substrate or electrical potentials coupled to the substrate.

The resistive losses in the conductors and the substrate of the transmission line as well as the dielectric losses contribute to the total loss experienced in a transmission line.

The terms loss or attenuation describe the reduction of a signal amplitude along the line due to these losses.

The term quality factor refers in the case of a transmission line that is driven on one side and open on the other (i.e. operated as a capacitor) to the ratio of the imaginary part of the admittance to the real part of the admittance seen at the driven input and in the case of a transmission line that is driven on one side and shorted to ground on the other side (i.e. operated as an inductor) to the ratio of the imaginary part of the impedance to the real part of the impedance seen at the driven input. The term quality factor does make sense only if the line length is much shorter than a quarter wave length of the signal transmitted within the transmission line.

The term line impedance or characteristic impedance refers to the impedance where the line is free from reflections if terminated with this impedance. The line impedance is proportional to the square root of the ratio of inductance per length l′ and capacitance per length c′ of the line.

Embodiments of the invention will be discussed below after discussing a common design of a waveguide.

FIG. 1a shows a 3D view of a waveguide 10 which is designed as a coplanar waveguide comprising a slotted shield in a layer parallel to the conventional coplanar waveguide structure. Here, the waveguide 10 comprises an inner conductor 12, also referred to as central signal line, and a pair of outer conductors 14a and 14b comprising a first outer conductor 14a and a second outer conductor 14b. The inner conductor 12 and outer conductors 14a and 14b are arranged in a first layer in parallel to each other to form the coplanar waveguide. Furthermore, the inner conductor 12 and the two outer conductors 14a and 14b are separated by a distance d₁₄ₐ_{_{—}}₁₂ and d_{14b}_{_{—}}₁₂, respectively.

In a second layer, which is parallel to the first layer, the waveguide comprises a slotted shield 16, wherein a plurality of slots of the slotted shield 16 and thus a plurality of slotted shield stripes are perpendicular to a main extension 18 which extends from a first side of the waveguide 10 to a second side and which is typically parallel to a propagation direction of guided wave. The distance between two slotted shield stripes is smaller than 1000 nm or preferably in a range between 50 and 250 nm. The width of the fingers of the slotted stripes is smaller than 1000 nm or preferably in a range between 50 and 250 nm. This very narrow distance of the slotted stripes depends on the used production technology, e.g. on the lithography process of the CMOS technology. The slotted shield 16 having the plurality of slots is electrically connected to the first and second outer conductors 14a and 14b by two vertical connections 20a and 20b. Therefore, the two outer conductors 14a and 14b are electrically connected via the slotted shield 16.

FIG. 1b shows a cross sectional view of the slotted waveguide 10 arranged on a substrate 22. Here, the first conductive (metal) layer M_{N} comprising the inner conductor 12 and the outer conductors 14a and 14b is spaced from the second layer Mₙ by a distance which is relatively small compared to the entire width w₁₀ of the waveguide 10, e.g. 5 to 100 times smaller, wherein the second (metal) layer Mₙ comprising the slotted shield 16 is arranged over the substrate 22. Furthermore, the inner conductor 12 is arranged between the two outer conductors 14a and 14b such that same is centered and separated by the distances d₁₄ₐ_{_{—}}₁₂ and d_{14b}_{_{—}}₁₂, which amount approximately to widths w₁₄ₐ or w_{14b} of the respective outer conductors 14a and 14b. A width w₁₂ of the inner conductor 12 amounts approximately to half of the width w₁₄ₐ or w_{14b} of the outer conductors 14a and 14b. The thickness of the inner conductor and of the outer conductors 14a and 14b may be equal within process tolerances and may be in a range between 0.4 μm and 10 μm. The substrate 22 may be a semiconductor substrate and may have a thickness of 250 μm or between 10 μm to 1000 μm and a resistivity which lies in a range between 0.1 ohm cm to 1000 ohm cm.

FIG. 1c shows a further cross sectional view of the waveguide 10, wherein further layers, M_{N-1} and Mₙ₊₁ are arranged between the first layer M_{N} and the second layer Mₙ such that the first and second layer M_{N} and Mₙ are spaced from each other. The further layers M_{N-1} and Mₙ₊₁ may comprise further outer conductors 24a and 24b and 26a and 26b. The further outer conductors 24a, 24b, 26a, and 26b are similar to the outer conductors 14a and 14b, respectively and are arranged parallel to the same. Here, the outer conductors 14a and 14b are electrically connected to the slotted shield 16 by vias 28a and 28b which are arranged along the respective outer conductor 14a and 14b. Via these vias 28a and 28b the further outer conductors 24a, 24b, 26a and 26b are electrically connected as well.

Below, the basic functionality of a waveguide shown with respect to FIGS. 1a to 1c will be discussed in detail.

The waveguide 10, also referred to as transmission line, may be used, for example, for high speed wireless (i.e.“60 GHz”) communications in the frequency range between 57-66 GHz (e.g. in a mobile communication device) or for radar sensors operating in a frequency range of 76-77 GHz or 79-81 GHz or around 94 GHz. A high frequency signal is transmitted through the waveguide 10 by using single ended signaling. Here, the high frequency signal may comply with an alternating voltage with a fixed reference voltage, for example a common ground. The inner conductor acts as a “hot” signal line, wherein the two outer conductors 14a and 14b act as a ground line so that an electromagnetic wave of the high frequency signal is transmitted through the waveguide 10. That is, the alternating voltage is applied between the inner conductor 12 and the outer conductors 14a and 14b and thus the slotted shield 16, wherein the fixed reference voltage, namely the common ground, is applied to the outer conductors 14a and 14b. Thus, the slotted shield 16 of the waveguide 10 acts as a ground shield (see coaxial cable).

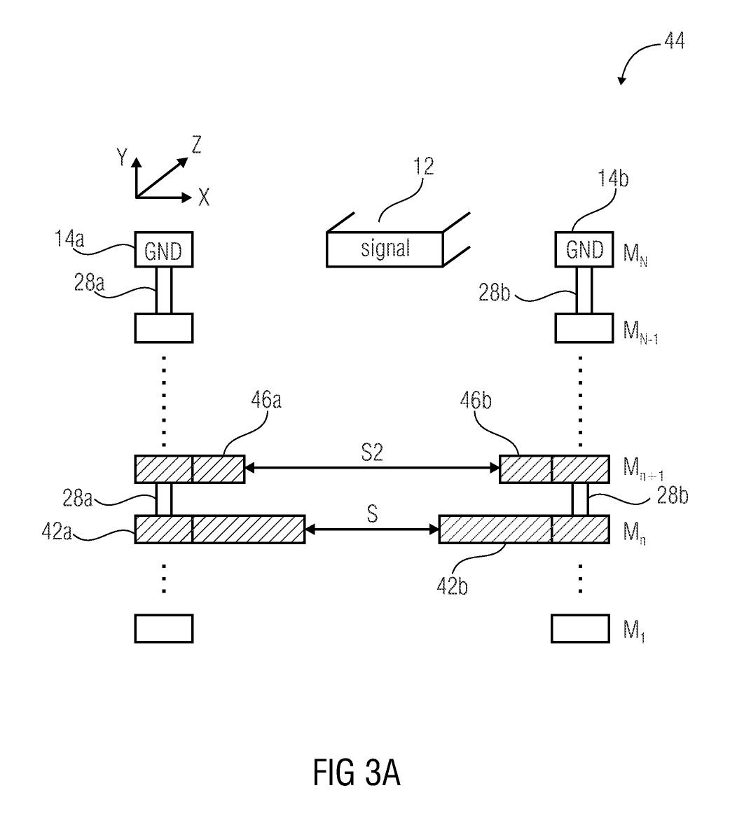

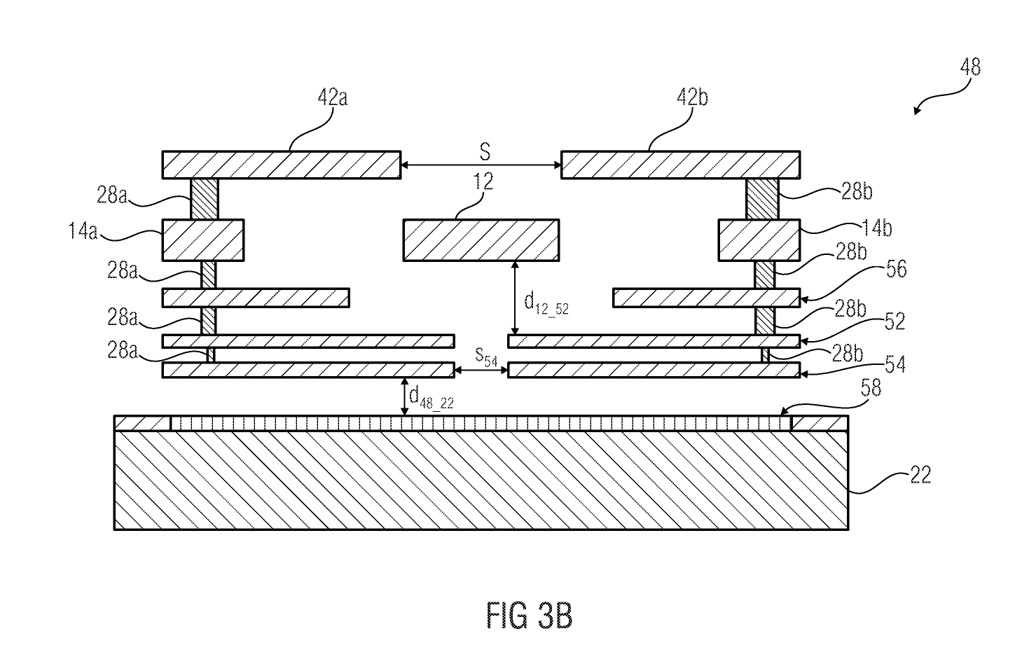

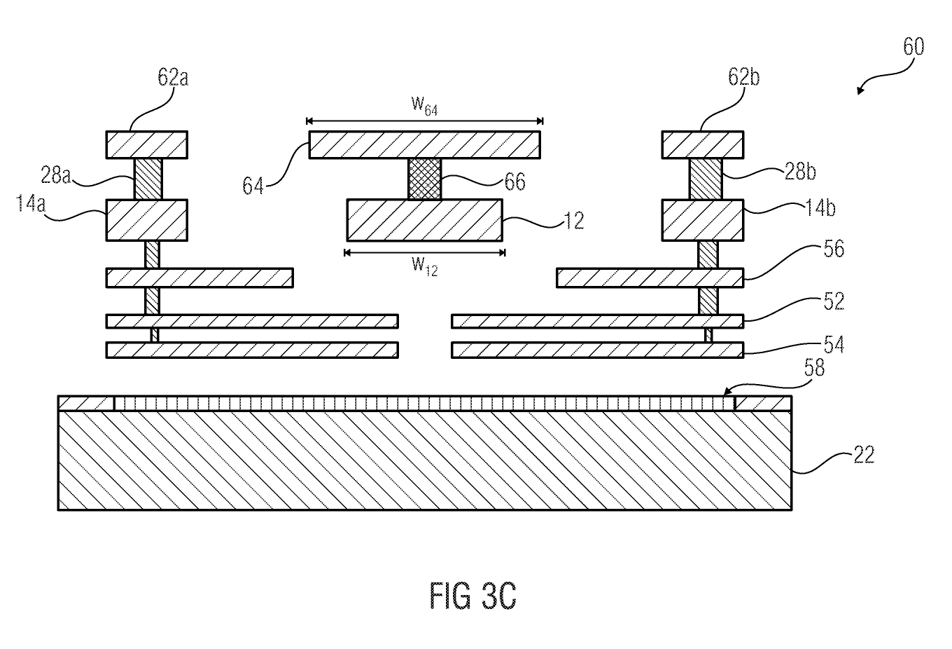

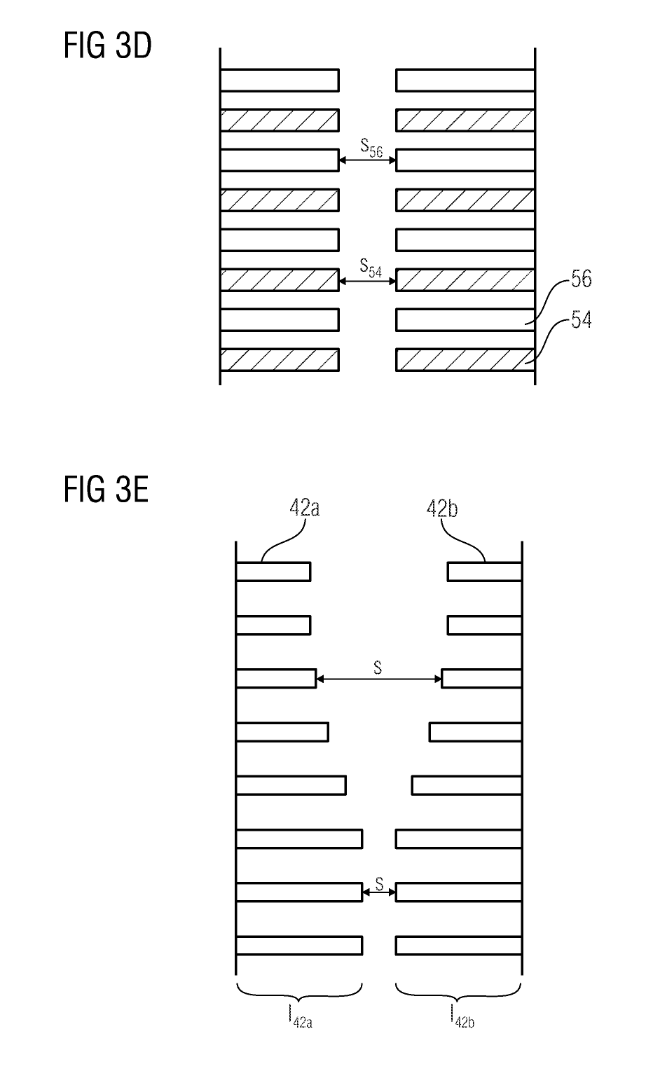

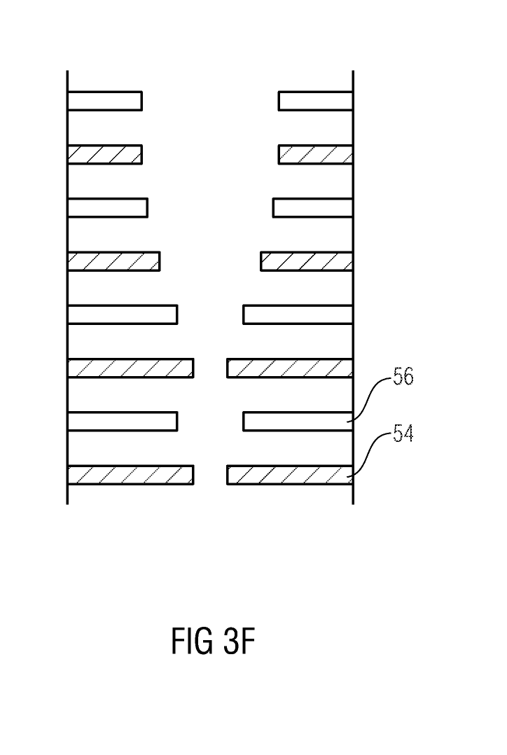

During the transmission the electromagnetic wave excited within the waveguide 10 is influenced by the waveguide 10. This influence depends on a so called quality factor of the waveguide 10 which is dependent on a capacitance and an inductance of the waveguide and thus by the impedance of the waveguide 10, as well as on the losses of the waveguide 10. The capacitance and the inductance are primarily a function of the geometry of the waveguide 10. Relevant geometry parameters are the entire width w₁₀, the spacing between the inner conductor 12 and the outer conductors 14a and 14b, and the distance between the inner conductor 12 and the slotted shield 16 (e.g. d₁₂₋₅₂ in FIG. 3b). The inductance per length of the transmission line increases with increasing spacing of the inner conductor 12 to the outer conductors 14a and 14b. The capacitance per length of the transmission line increases with decreasing distance of the inner conductor to the slotted shield 16. The entire width w₁₀ may preferably be adapted to the frequency or the wavelength of the high frequency signal for the transmission of which the waveguide 10 is designed. Depending on the respective application of the waveguide 10 the length of same (along the extension 18) between a first side and a second side may be a predefined fraction or multiple of the wavelength. The waveguide 10 may have a small area consumption and small length compared to a free space wavelength L. The small area consumption and area reduction, respectively, is based on reduction of the phase velocity (v) or group velocity of the electromagnetic wave to be transmitted (e.g. when compared to a free space phase velocity or group velocity). The relation v=λ*L with λ being the frequency of the electromagnetic wave and L the wavelength of same shows that an electromagnetic wave with a small phase velocity v leads to a small wavelength and so a short line length for a quarter wavelength impedance transformer. Due to this small or slow phase velocity being smaller than the phase velocity of light in the vacuum, this type of waveguide 10 or transmission line is called a slow wave transmission line. In general the phase velocity v is dependent on the inductance per length l′ and capacitance per length c′ of the line according the following relation: v˜l/sqrt(l′*c′), i.e. the larger l′ and c′ get the smaller the phase velocity v and so the wave length L.

A further factor of influence is the selected materials for the inner conductor 12, the outer conductors 14a and 14b, the slotted shield 16, the substrate 22 and the dielectric (not shown) between the single conductors and layers. These materials influence the resistivity, i.e. the loss of the line, the impedance or characteristic impedance, and the quarter wave length of the waveguide 10.

The capacitance and the inductance (and thus the impedance) are selected such that the electromagnetic wave is carried with minimal reflections to avoid interferences within the waveguide 10 and to achieve a small area of the device. In general a smaller device allows also reducing losses. By adapting these factors of influence the transmission and thus signal quality and line loss per transmission line length may be controlled. This may be especially necessary for transmission lines that need to connect different circuit parts that are separated over larger distances, e.g. more than a quarter wave length.

High line loss and low high frequency performance of active devices are especially an issue for handheld battery powered mobile (communication) devices in the frequency range above 20 GHz (mm-wave region). The reduction of loss of the line or of its attenuation is limited for higher frequencies due to the increasing loss with high frequencies and the reduced conductivity of thin metal layers in scaled CMOS technologies. The lower gain of active devices with higher frequencies and the decreased power delivering capability of scaled CMOS due to a reduced supply voltage in addition leads to power inefficient circuits in CMOS in the mm-wave region. As the area consumption of devices in general naturally reduces with increasing frequency the area of devices is not so much a concern as it is the loss for circuits operating in the mm-wave region.

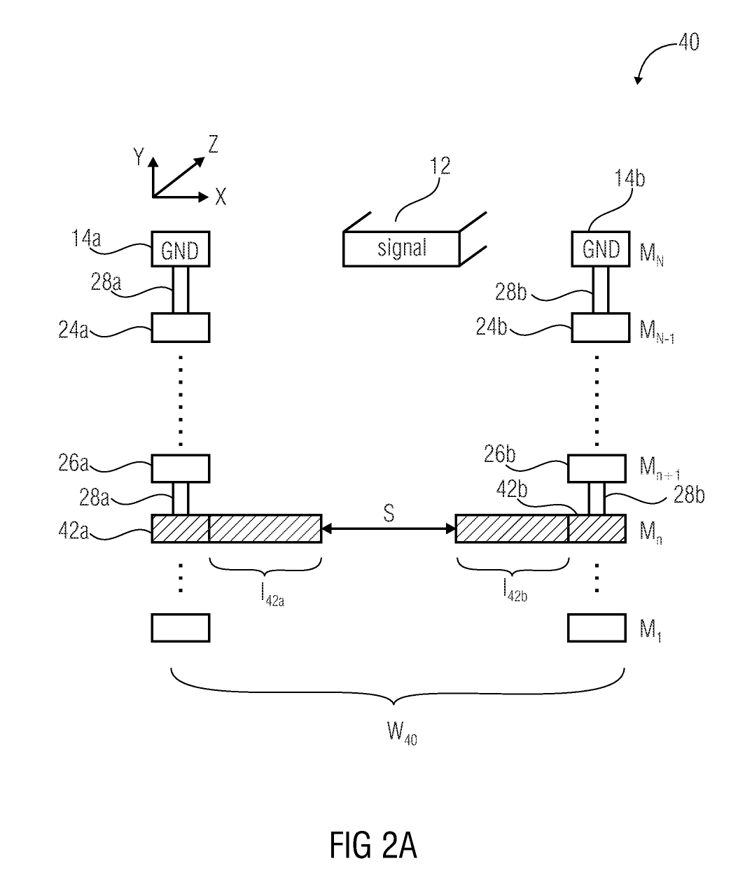

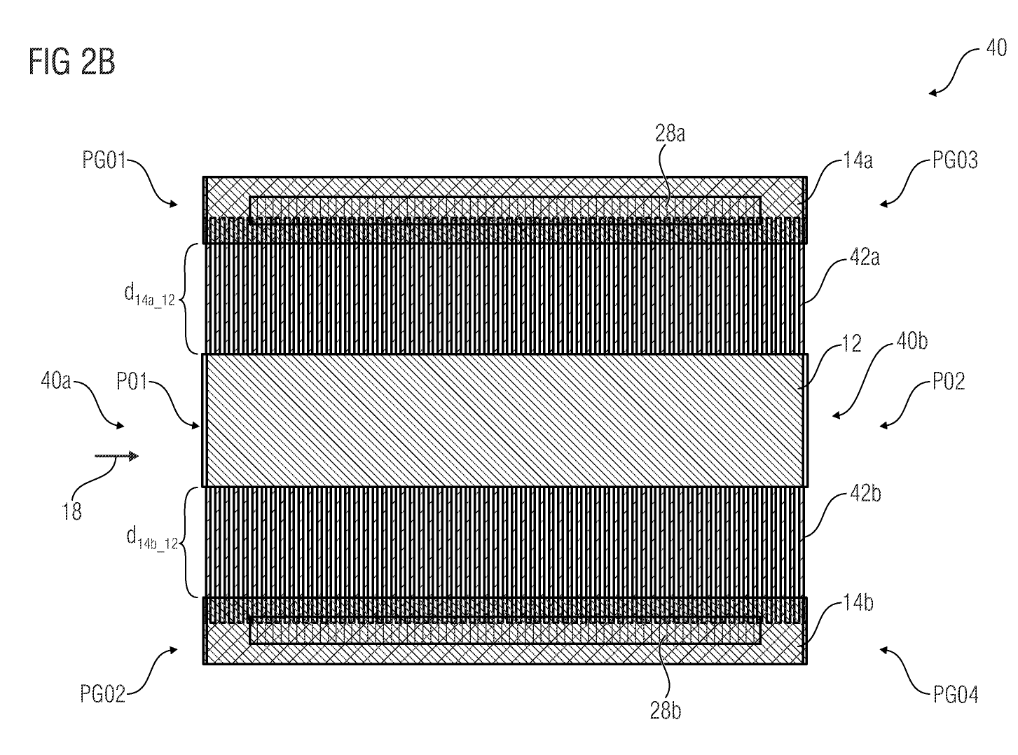

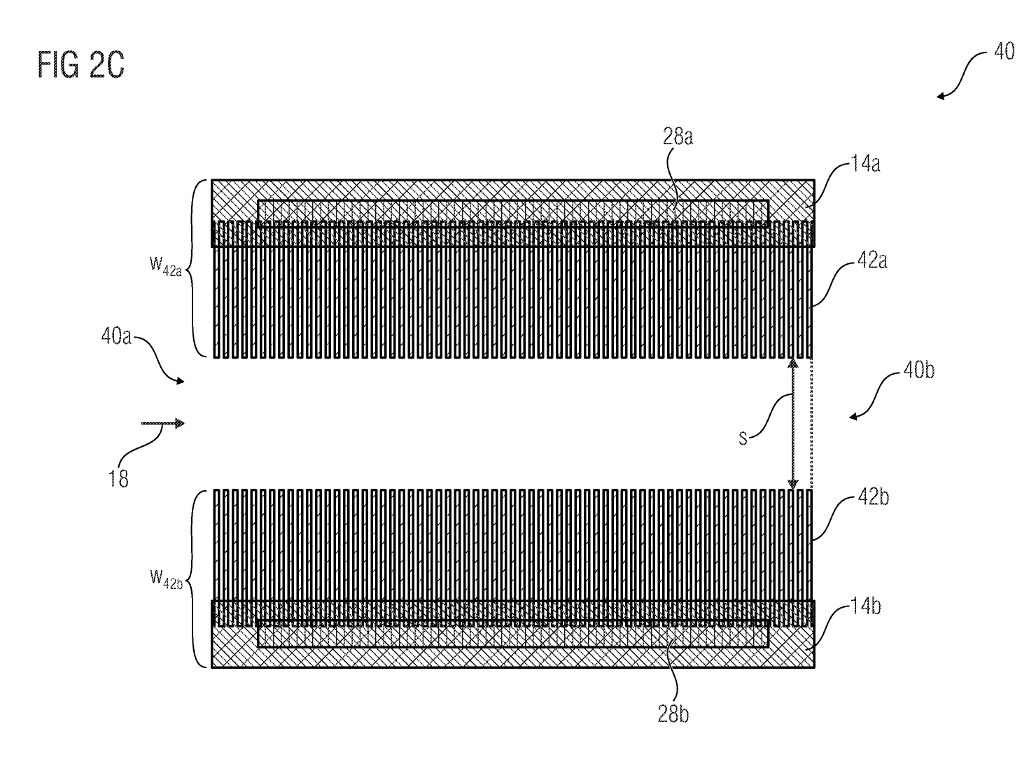

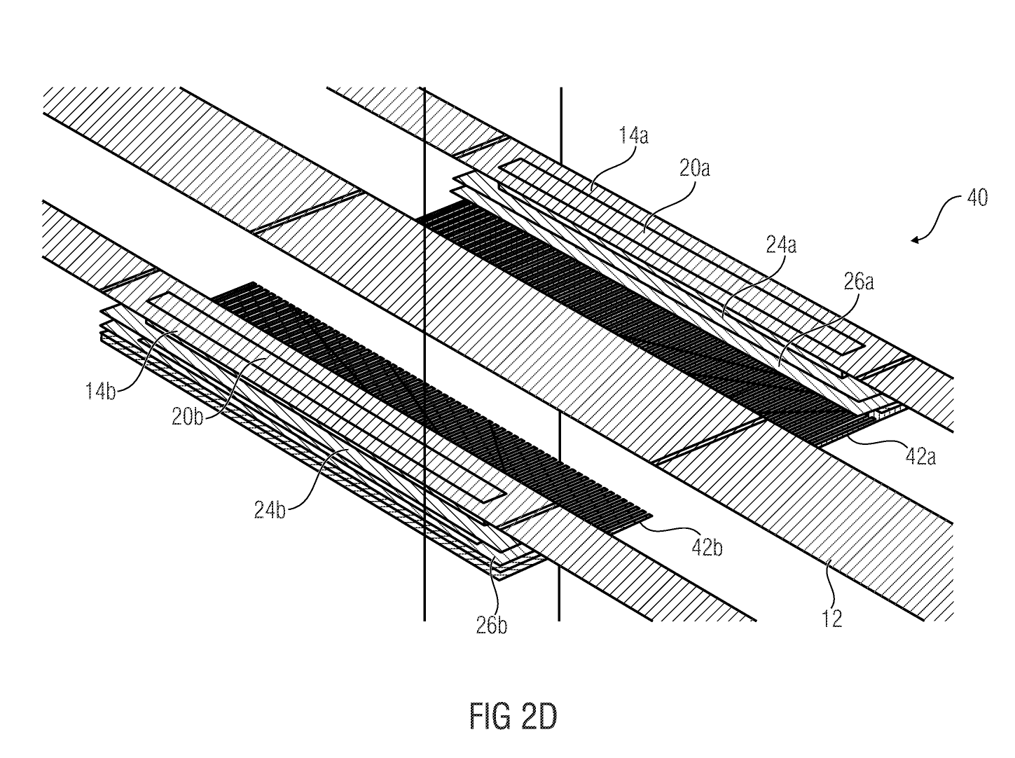

Therefore, there is a need for an improved approach for reducing the loss or increasing the quality factor of a waveguide device. This improved approach will be discussed in detail referring to FIGS. 2a to 2d.

FIG. 2a shows a waveguide 40 which comprises an inner conductor 12 arranged in a first layer M_{N}, and a pair of outer conductors 14a and 14b comprising a first outer conductor 14a and a second outer conductor 14b also arranged in the first layer M_{N} and parallel to the inner conductor 12. The waveguide 40 further comprises a pair of slotted shields 42a and 42b comprising a first slotted shield 42a and a second slotted shield 42b. The first and second slotted shields 42a and 42b are arranged in a second layer Mₙ with a spacing s in between to form a section of a ground shield. In contrast to the waveguide 10 shown in FIGS. 1a-1c, the slotted shields 42a and 42b of the waveguide 40 are disconnected or separated by the spacing s. In other words, the slotted shields 42a and 42b are typically not directly electrically connected within the second layer Mₙ over a length of at least 0.2 times the waveguide wavelength of high frequency signals for which the waveguide 40 is designed. In some embodiments, the slotted shields 42a and 42b are not directly connected within the second layer Mₙ over a length of at least 0.1 times or 0.4 times the waveguide wavelength of high frequency signals.

In this embodiment, the spacing s between the two slotted shields 42a and 42b is equal (e.g. within a processing tolerance of +/−10%) to the width w₁₂ of the inner conductor 12. In general, the spacing s may be in a range between half (or 0.1) the width of w₁₂ of the inner conductor 12 and five times the width w₁₂. Furthermore, the width w₄₂ₐ or w_{42b} is typically larger by at least 1 μm than the width w₁₄ₐ or w_{14b} to form the ground shield around the inner conductor 12.

The first slotted shield 42a is electrically connected to the first outer conductor 14a, for example, via the one or more vias 28a, wherein the second slotted shield 42b is electrically connected to the second outer conductor 14b, for example, via the one or more vias 28b. Due to the “disconnected” slotted shields 42a and 42b which are separated by the spacing s the two outer conductors 14a and 14b are not electrically connected (at least at DC or at a frequency of 0 Hz), for example at least over a portion of the waveguide 40 having a length of 0.2 times the waveguide wavelength of high frequency signals for which the waveguide 40 is designed. The plurality of slot stripes are of equal lengths l₄₂ₐ and l_{42b}, but may, alternatively, have a varying length, as will be described with respect to FIGS. 3e and 3f. In this embodiment, the outer conductors 14a, 14b, 24a, 24b, 26a and 26b as well as the slotted shields 42a and 42b are arranged such that the outer boundaries of the outer conductors 14a, 24a and 26a and the slotted shield 42a are aligned to each other and such that the outer boundaries of the outer conductors 14b, 24b and 26b and the slotted shield 42b are aligned to each other. In other words, each structure in their respective metal layer M_{N}, M_{N-1}, Mₙ₊₁ and Mₙ formed by the outer conductors 14a, 14b, 24a, 24b, 26a and 26b and the slotted shields 42a and 42b are arranged such that each structure has the same overall width w₄₀ which is equal to the entire width w₄₀ of the waveguide 40. Furthermore, the inner conductor 12, the outer conductors 14a, 14b, 24a, 24b, 26a and 26b and the slotted shields 42a and 42b are arranged such that its inner boundaries are parallel and/or such that the inner boundaries of the outer conductors 14a, 14b, 24a, 24b, 26a and 26b and of the slotted shields 42a and 42b are arranged around the inner conductor 12.

FIG. 2b and FIG. 2c show a top views of the waveguide 40, wherein the inner conductor 12 is hidden in FIG. 2c for illustrating the spacing s between the two slotted shields. In this embodiment, the waveguide 40 and thus the inner conductor 12 and the pair of outer conductors 14a and 14b which are parallel to the inner conductor 12 are straight. In other words, the waveguide 40 and thus the inner conductor 12 extend along a straight main extension 18 from the first side 40a to a second side 40b of the waveguide 40. The spacing s extends along the main extension 18 and thus along the inner conductor 12.

The first slotted shield 42a and the second slotted shield 42b comprise a plurality of slots and slotted shield stripes, respectively, which are arranged in the second layer Mₙ. The plurality of slots are parallel to each other and perpendicular to the main extension 18 of the inner conductor 12, for example, within a tolerance of +/−10 degree. In other words, the plurality of slotted shield stripes extends in a direction perpendicular to the inner conductor 12 when seen in a projection perpendicular to the main surface of the layers. The width of each slotted shield stripe may be in a range between 50 μm and 250 μm, wherein the plurality of slotted shield stripes of the slotted shields 42a and 42b may have the same width, i.e. w₄₂ₐ=w_{42b}. Each slotted shield comprises a non-slotted portion which connects the plurality of slotted shield stripes of the respective slotted shield 42a or 42b. This non-slotted portion which is arranged at the “outer” side of the slotted shields 42a and 42b (i.e. remote from the central part where the first slotted shield 42a and the second slotted shield are separated by the spacing s) may have a width which is equal or preferably smaller compared to the width w₁₄ₐ or w_{14b} of the first or second outer conductor 14a or 14b.

FIG. 2d shows a 3D view of the waveguide 40 which comprises further layers with further pairs of outer conductors 24a, 24b, 26a and 26b. As explained with respect to FIG. 2c, the waveguide 40 may have additional layers between the first layer M_{N} and the second layer Mₙ, namely the layers M_{N-1} and Mₙ₊₁, which comprise the further outer conductors 24a, 24b, 26a and 26b. The first set of outer conductors comprising the outer conductor 14a, 24a and 26a is electrically connected to the slotted shield 42a via the vertical connection 20a, while the second set of outer conductors comprising the outer conductors 14b, 24b and 26b is electrically connected to the second slotted shield 42b via the vertical connection 20b.

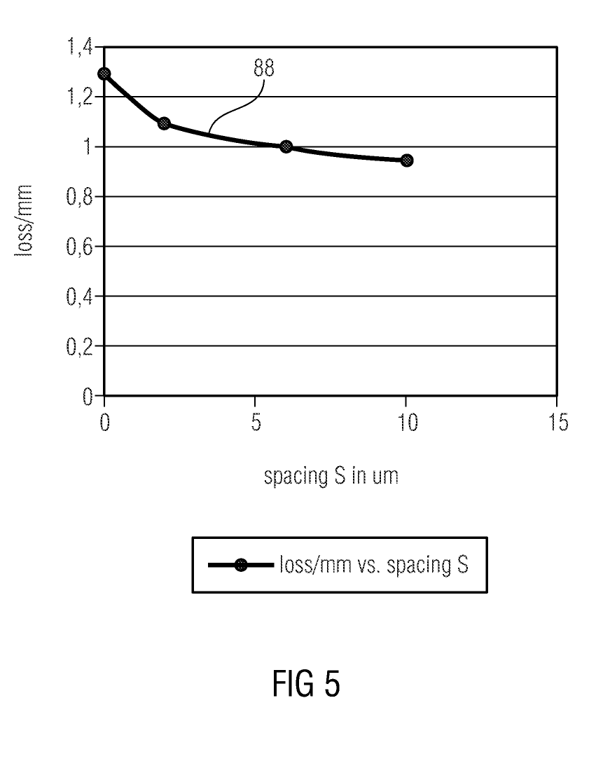

Regarding the functionality of the embodiment of the waveguide 40 shown in FIGS. 2a to 2d it should be noted this functionality complies substantially with the functionality of the waveguide 10 shown in FIGS. 1a to 1c. However, the waveguide 40 is beneficial with respect to the transmission behavior including noise and power added efficiency. The waveguide 40 has an improvement in loss, attenuation or quality factor achieved by disconnecting (or separated) the slotted shields 42a and 42b and thus the outer conductors 14a and 14b of the coplanar waveguide. This spacing results in a reduction in loss of the waveguide 40 (or of a quarter wavelength transformer comprising said waveguide 40), as will be discussed with respect to FIG. 5. The background thereof is that the loss in the slotted shields 42a and 42b may be reduced by an adapted combination of the slotted shield parameters, as will be discussed with respect to FIG. 5.

To sum up, the shown design of the waveguide 40 enables an improved transmission by using the waveguide 40 which has the same width w₄₀ (cross sectional size in x-direction) of a conventional waveguide 10 (see width w₁₀). It should be noted that the above discussed design may change the wavelength and so the length of the waveguide 40 (the dimension in z-direction) when compared to the conventional waveguide 10. Furthermore, the above discussed design of the waveguide 40 enables reducing the area consumption of the transmission line, wherein the area consumption is basically dependent on the used frequency range of the signal to be transmitted, as discussed above.

According to another embodiment, such a waveguide 40 or transmission line may be used as a quarter wavelength transformer. The quarter wavelength impedance transformer consists of a portion of the waveguide 40 exactly (or at least approximately) one quarter of a wavelength (L) long and terminated in some known impedance. Such quarter wavelength impedance transformers may be used as filters. The shown quarter wavelength impedance transformer using the waveguide 40 achieves a high quality factor when used as an inductor or capacitor or achieves a small attenuation per line length. Furthermore, the quarter wavelength impedance transformer 40 may be used as or in a balun (-circuit) performing a conversion from a single ended signal to a differential signal together with an impedance transformation. Such baluns are useful in the design of differential low-noise amplifiers fed by a single ended antenna and as a power combining and impedance transforming element at the output of a (pseudo-) differential push-pull configured power amplifier.

FIG. 3a shows a further embodiment of a waveguide 44 which corresponds to the waveguide 40, wherein an additional pair of slotted shields 46a and 46b is arranged in an additional layer Mₙ₊₁ instead of the further pair of outer conductors 26a and 26b. This additional pair of slotted shields 46a and 46b comprising a third slotted shield 46a and a fourth slotted shield 46b is substantially equal to the first pair of slotted shields comprising the first slotted shield 42a and the second slotted shield 42b, wherein a spacing s2 between the third and fourth slotted shields 46a and 46b is larger compared to the spacing s between the first and second slotted shields 42a and 42b. The two slotted shield pairs 46a/46b and 42a/42b may be arranged topologically in a inter digitized manner as shown in FIGS. 3e and 3f where a slot in the slotted shield 42/a/42b is covered by a slot finger of the slotted shield 46a/46b. By this way it is guaranteed that no portion of the substrate under the slotted shield is electrically exposed to the inner conductor 12.

The third slotted shield 46a is electrically connected to the first slotted shield 42a via the vias 28a and thus electrically connected to the first outer conductor 14a. Similarly, the fourth slotted shield 46b is electrically connected to the second slotted shield 42b and to the second outer conductor 14b via the vias 28b. Here, the additional layer Mₙ₊₁ is arranged between the first layer M_{N} and the second layer Mₙ, but the additional layer Mₙ₊₁ may, alternatively, be arranged such that the first M_{N} is between the additional layer Mₙ₊₁ and the second layer Mₙ. It is advantageous that the shielding of the ground shield of the waveguide 44 formed by the two pairs of slotted shields having the slotted shields 42a, 42b, 46a and 46b is further improved.

FIG. 3b shows a further embodiment of a waveguide 48, wherein the inner conductor 12 is enclosed by a plurality of ground shields formed by four pairs of slotted shields. The four pairs of slotted shields are arranged in different layers on a substrate 22. The inner conductor 12 and the pair of outer conductors 14a and 14b are arranged in the first layer, wherein the pair of slotted shields comprising the first and second slotted shield 42a and 42b is arranged in an upper layer. The three further pairs of slotted shields are arranged in lower layers. Here, two similar pairs of slotted shields 52 and 54 are arranged adjacent to the substrate 22 and the pair of slotted shields 56 is arranged in a layer between the first layer and the layers of the pairs of slotted shields 52 and 54.

A spacing s₅₄ and s₅₂ of the pairs of slotted shields 52 and 54 is smaller than a spacing of the pair of slotted shields 56. The spacing of the pair of slotted shields 56 is larger than the spacing s of the pair of slotted shields comprising the slotted shields 42a and 42b, or vice versa. The pair of slotted shields 56 as well as the pair of slotted shields comprising the slotted shields 42a and 42b do not overlap the inner conductor 12 because its spacing is larger than the width w₁₂. In contrast the two similar pairs of slotted shields 52 and 54 overlap the inner conductor 12 because the spacing s₅₄ and s₅₆ between these pair of the slotted shields 52 and 54 is smaller than the width w₁₂ of the inner conductor 12. The distance d₁₂_{_{—}}₅₂ between the inner conductor 12 (the boundary of the inner conductor 12) and the adjacent overlapping slotted shield 52 (the adjacent boundary of the slotted shield 52) may be in a range between 0.1 to 30 μm.

The slotted shield 42a is electrically connected to the outer conductor 14a and to the further respective slotted shields of the three lower pairs of slotted shields 52, 54 and 56 via vias 28a. It should be noted that the size of the vias 28a and 28b may be reduced from upper layers to lower layers. In other words, the vias between the first layer, the layer of the slotted shields 56 and the layer of the slotted shields 52 are smaller than the vias between the first layer and the layer of the pair of slotted shields comprising the slotted shields 42a and 42b, but larger than the vias between the layer of the slotted shields 52 and the layer of the slotted shields 54.

An effective conductivity of the slotted shields is influenced by its thickness and by its specific conductivity which is in turn a function of the layer thickness and slotted shield finger width as described above. A thickness of the pairs of slotted shields 52 and 54 which may be in a range between 10 nm and 100 nm or in a range between 100 nm and 1000 nm is smaller than the thickness of the pair of slotted shields 56, wherein the thickness of the pair of slotted shields 56 is smaller than the thickness of the pair of slotted shields comprising the slotted shields 42a and 42b. The specific conductivity of the conductive material used for the pair of slotted shields 52 and 54 or for the pair of slotted shields 56 or for the pair of slotted shields comprising the slotted shields 42a and 42b may be in a range of 5 10⁵ to 5 10⁷ S/m. Therefore the effective conductivity of the different slotted shields may vary.

In another embodiment the pair of slotted shields 42a and 42b may be connected, i.e. the spacing s is zero, while the pairs of slotted shields 56, 52 and 54 stay with their spacing as shown in FIG. 3b. In another embodiment one of the pairs of slotted shields 56, 52 or 54 may be connected, i.e. the respective spacing s₅₆, s₅₂ or s₅₄, respectively, is zero, while the pairs of slotted shield 42a and 42b contain a spacing s which is not zero as shown FIG. 3b.

FIG. 3c shows a waveguide 60 which comprises two electrically connected inner conductors. In this embodiment, the pairs of slotted shields 52, 54 and 56 as well the inner conductor 12 and the pair of outer conductors 14a and 14b in the first layer comply with the embodiment of the waveguide 48 shown in FIG. 3b. In contrast, the waveguide 60 comprises a further pairs of outer conductors 62a and 62b in the upper layer instead of the slotted shields 42a and 42b. Between these outer conductors 62a and 62b a further inner conductor 64 is arranged. The first inner conductor 12 and the second inner conductor 64 are arranged such that they are parallel and aligned to each other. A width w₆₄ of the second inner conductor 64 is larger than the width w₁₂ of the inner conductor 12. The width w₆₄ of the second inner conductor 64 may be equal to the spacing between the pair of slotted shields 56. This inner conductor 64 is electrically connected to the inner conductor 12 via an electrical connection 66, e.g. a via. Similarly, the outer conductor 62a is connected to the outer conductor 14a via the vias 28a and the outer conductor 62b is connected to the outer conductor 14b via the vias 28b.

Bellow, three embodiments of a waveguide having three different lateral arrangements of the slotted shield along the main z-direction (refer to FIG. 2a or 18 in FIG. 1a and FIG. 2b/c) of the transmission line will be discussed.

FIG. 3d shows a top view of the two pairs of slotted shields 54 and 56 of the waveguide 48 according to FIG. 3b for illustrating a possible lateral arrangement of the pairs 54 and 56. In this embodiment, the pair of slotted shields 54 is displaced against the pair of slotted shields 56 in the z-direction. Therefore, the fingers of the slotted shield 54 fall into the slots of the slotted shield 56, and vice versa. The width and spacing of the fingers of each of the slotted shields 54 and 56 may be arranged that the fingers of the slotted shields 54 and 56, which are in different layers, do not overlap or do overlap.

FIG. 3e shows a pair of slotted shields 42a and 42b of a waveguide which may be equal to the waveguide 40 shown in FIGS. 2a to 2d. In this embodiment the spacing s varies over the length of the waveguide. Therefore, the lengths l₄₂ₐ and l_{42b} of the slotted shield stripes vary such that the spacing s at the first side is smaller than the spacing s at a second side. In other words, the spacing s may vary according a (continuous) function. Furthermore, the lengths l₄₂ₐ and l_{42b} of two facing slotted shield stripes may be preferably, but not necessarily equal.

It should be appreciated that the transmission line comprising a spaced slotted shield allows a fundamental change of electrical characteristics of the line, as e.g. the impedance of the line, by changing the shield spacing along the length of the line within a fixed transmission line size width w₄₀. Such a tapered transition of the shield spacing enables a change in the impedance for an impedance matching between two circuit parts.

FIG. 3f shows a combination of the embodiments of FIG. 3d and FIG. 3e. Here, the two pairs of slotted shields 54 and 56 of the waveguide 48 are arranged as discussed with respect to FIG. 3d, wherein the spacing s₅₄ and s₅₆ vary in accordance with a function, as described with respect to FIG. 3e. It should be noted that the function in accordance to which the spacings s₅₄ and s₅₆ vary are not necessarily the same so that the length of two slotted shield stripes which are adjacent, but in different layers may differ discontinuously.

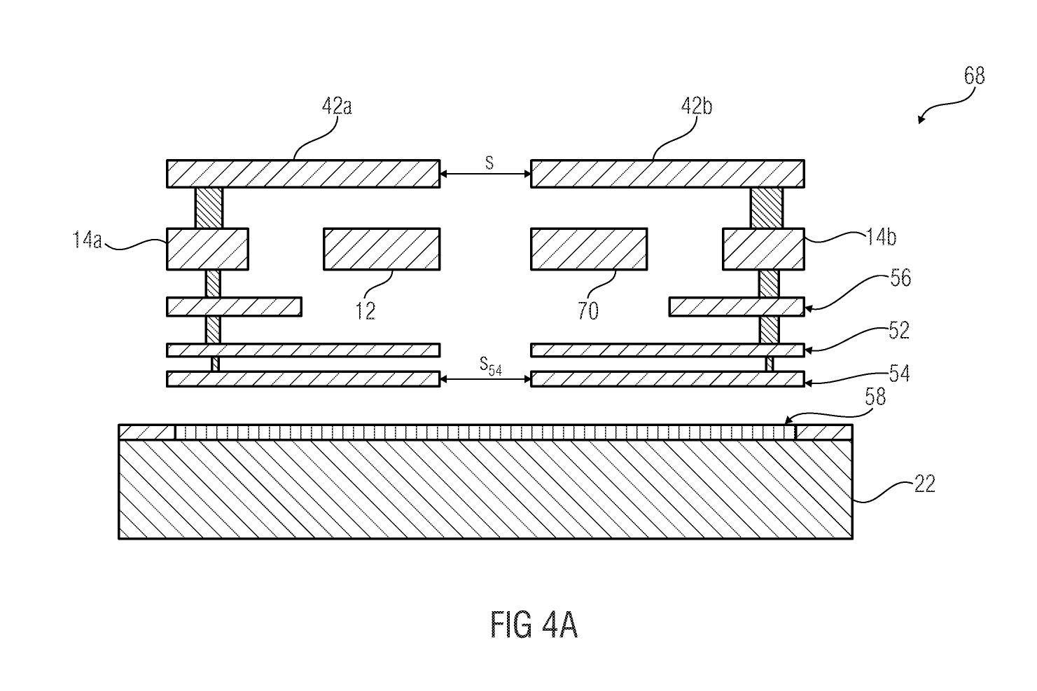

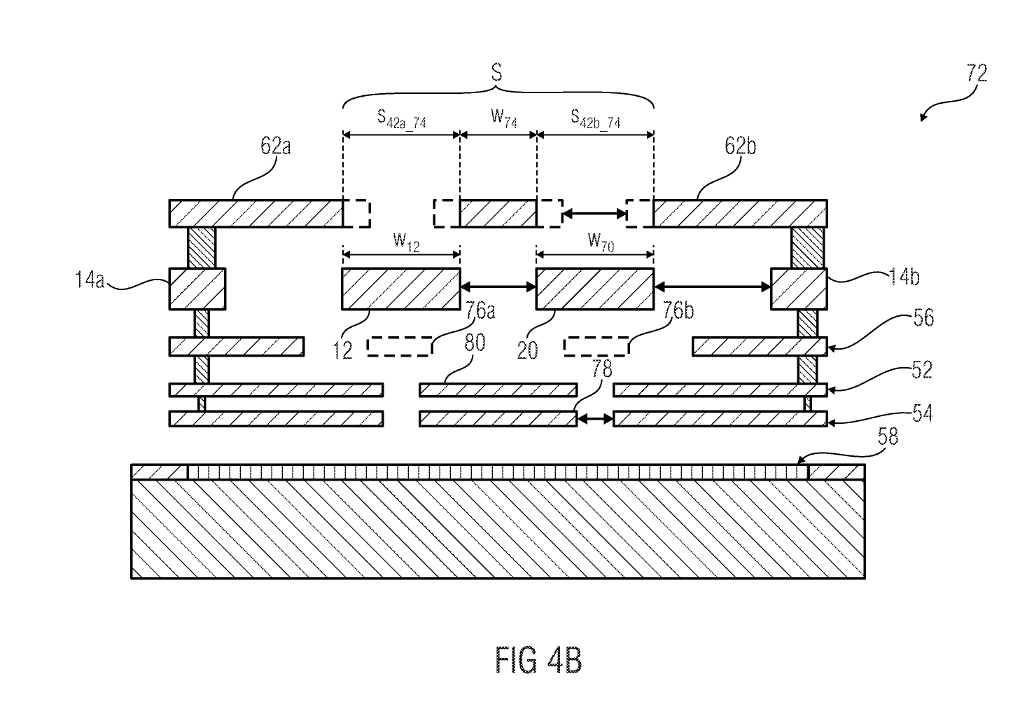

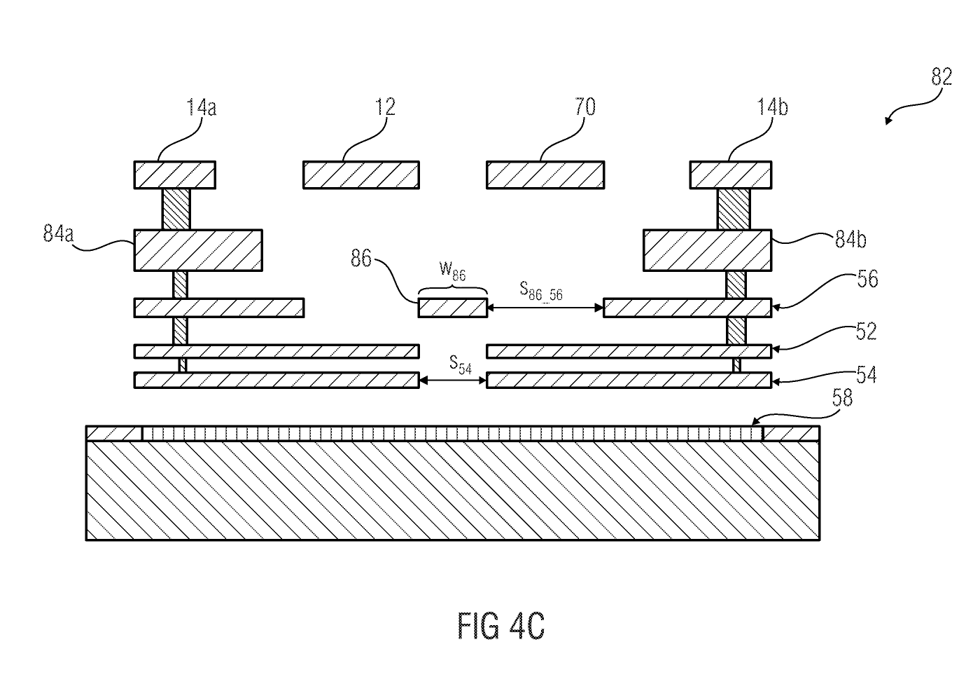

FIG. 4a shows a further embodiment of a waveguide 68 which comprises two inner conductors in the first layer.

The waveguide 68 is equal to the waveguide 48, but further comprises an additional inner conductor 70 which is arranged in the first layer (i.e. in the same layer of the first inner conductor 12). The inner conductor 70 has a width w₇₀ which is equal compared to the width w₁₂. A distance from the inner conductor 12 to the outer conductor 14a is equal compared to the distance between the inner conductor 70 and the outer conductor 14b. The spacing s₁₂_{_{—}}₇₀ between the two inner conductors 12 and 70 is equal to the spacing s between the two slotted shields 42a and 42b. The spacing s₅₄ of the pair of slotted shields 54 and thus of the pair of slotted shields 52 is also equal to the spacing s. Here, it is advantageous that a differential signal may be transmitted through the two inner conductors 12 and 70, which are isolated from each other, for example by a dielectric.

FIG. 4b shows the further embodiment of a waveguide 72 which complies with the waveguide 68 but comprises an electrically conductive fill structure 74 between the first slotted shield 42a and the second slotted shield 42b and two similar centered electrically conductive fill structures 78 and 80 arranged between the respective slotted shields of the two pairs of slotted shields 54 and 56. In other words, the electrically conductive fill structures 74, 78 and 80 are aligned with each other but arranged in different layers.

In this embodiment, the spacing s between the two slotted shields 42a and 42b is enlarged compared to the embodiment of FIG. 4a. The electrically conductive fill structure 74 has a spacing s₄₂ₐ_{_{—}}₇₄ against the first slotted shield 42a and a spacing s_{42b}_{_{—}}₇₄ against the second slotted shield 42b such that same is electrically isolated from the slotted shields 42a and 42b. The spacing s₄₂ₐ₋₇₄ complies with the spacing s_{42b-74} and may be equal to the width w₁₂ and width w₇₀, respectively, such that same is centered. Therefore, the spacing s between the two slotted shields 42a and 42b amounts to the sum of the spacing s₄₂ₐ_{_{—}}₇₄ (equal to the width w₁₂), the spacing s_{42b}_{_{—}}₇₄ (equal to the width w₇₀) and a width w₇₄ of the electrically conductive fill structure 74 (equal to the spacing s₁₂_{_{—}}₇₀).

According to a further embodiment, the slotted shields 42a and 42b as well as the electrically conductive fill structure 74 may be enlarged such that same are overlapping the two inner conductors 12 and 70. This embodiment is illustrated by broken lines in FIG. 4b. According to another embodiment also illustrated by broken lines, one or more electrically conductive fill structures 76a and 76b may be arranged in the same layer, namely in the layer of the pair of slotted shields 56 such that the electrically conductive fill structures 76a and 76b are arranged between the slotted shields of the pair of slotted shields 56. These two electrically conductive fill structures 76a and 76b may be parallel to the respective inner conductor 12 or 70 and/or may be arranged such that same are aligned with the inner conductor 12 and the inner conductor 70, respectively. The spacing between the two electrically conductive fill structures 76a and 76b is larger than the spacing between the respective electrically conductive fill structure 76a or 76b and the respective slotted shield of the pair of slotted shields 56. The width of the floating shields 76a and 76b is equal or larger than the spacing of the floating shields 52 and 54 to fully overlap the opening of the spaced slotted shields 52 and 54.

Each electrically conductive fill structure 74, 78 and 80 are arranged such that same form a floating shield for the differential transmission line. This floating shield leads to a further improvement of the shielding of the waveguide 72.

FIG. 4c shows a further embodiment of a waveguide 82, which is equal to the waveguide 68, wherein the first layer, comprising the pair of outer conductors 14a and 14b as well as the two inner conductors 12 and 70, is the top layer of the waveguide 82. Between the first layer and the layers of the pairs of slotted shields 52, 54 and 56 a further layer is arranged which comprises two outer further conductors 84a and 84b which are larger than the outer conductors 14a and 14b. As discussed above, the spacing s₅₄ between the respective slotted shields of the pairs of slotted shields 54 and 52 is equal to the spacing s₁₂_{_{—}}₇₀ between the first and second inner conductor 12 and 70, respectively.

According to another embodiment, a further electrically conductive fill structure 86 is arranged between the slotted shields of a pair of slotted shields 56. The width w₈₆ of the electrically conductive fill structure is equal to the spacing s₅₄, wherein the spacing s₈₆_{_{—}}₅₆ between the fill structure 86 and the respective slotted shield of the pair of slotted shields 56 is equal to the width w₁₂ of the first inner conductor 12 and to the width w₇₀ of the second inner conductor 70.

FIG. 5 shows a diagram of the (relative) loss per millimeter resulting from a simulation of an electromagnetic field solver. The diagram is plotted over values of the spacing s between the first and second slotted shield. As illustrated by a graph 88, the spacing s has a significant impact on the loss of the waveguide and the transmission line, respectively. An increased spacing s may, for example, lead to a reduction of the loss per millimeter within the waveguide under following embodiment conditions:

Substrate resistivity equal or higher than 18 Ohms*cm and slotted shield metal layer thickness smaller than 900 nm and distance of inner conductor lowest layer M_{N} (12 in FIG. 2a or 12 in FIG. 3c) to slotted shield lowest layer Mₙ smaller than 9 μm and distance of slotted shield lowest layer Mₙ to substrate larger than 100 nm.

Substrate resistivity equal or higher than 7 Ohms*cm and slotted shield metal layer thickness smaller than 180 nm and distance of inner conductor lowest layer M_{N} (12 in FIG. 2a or 12 in FIG. 3c) to slotted shield lowest layer Mₙ smaller than 5 μm and distance of slotted shield lowest layer Mₙ to substrate larger than 150 nm.

Substrate resistivity equal or higher than 0.5 Ohms*cm and slotted shield metal layer thickness smaller than 110 nm and distance of inner conductor lowest layer M_{N} (12 in FIG. 2a or 12 in FIG. 3c) to slotted shield lowest layer Mₙ smaller than 3.5 μm and distance of slotted shield lowest layer Mₙ to substrate larger than 200 nm.

It should be noted that embodiments of this invention are not limited to this conditions.

Referring to FIGS. 1 to 4, it should be noted that the lowest layer where a slotted shield is formed can include a gate material of an MOS transistor, e.g. a silicided poly silicon or a metal gate of a high-k metal gate CMOS technology, or even a silicided portion of the substrate.

Referring to FIG. 1c, it should be noted that between the first layer M_{N} and the second layer Mₙ more than the shown two further layers M_{N-1} and Mₙ₊₁ may be arranged. Consequently, further outer conductors may be arranged in these further layers.

Referring to FIGS. 1c and 2a, it should be noted that between the substrate (not shown) and the second layer Mₙ further layers M₁ (e.g. with further outer conductors) may be possible or possibly arranged.

Referring to FIGS. 2a-2d it should be noted that the outer conductors 14a and 14b must not necessarily be arranged in the same layer of the inner conductor 12.

Referring to FIGS. 2a and 2d, the further layer M_{N-1} comprising the further pair of outer conductors 24a and 24b is, according to another embodiment, arranged such that the layer M_{N-1} is between the first layer M_{N} and the second layer Mₙ.

Referring to FIG. 2d, it should be noted that the waveguide 40 and thus the inner conductor 12 may curved or comprise a bend. Consequently, the two outer conductors 14a and 14b as well as the further outer conductors 24a, 24b, 26a and 26b as well as the slotted shields 42a and 42b may be curved too. Here, the first and second outer conductor 14a and 14b may be electrically connected in the curved area or in the area where the inner conductor 12 comprises the bend, for example by using an electric bend connection which is arranged in a higher or lower layer. In an embodiment the spacing s between the slotted shield may be reduced to zero in the curved area to achieve such an electrical connection. Due to this electric bend connection, differences of the potential between the first outer conductor 14a and the inner conductor 12 and between the second outer conductor 14b and the inner conductor 12 may be compensated. This leads to an improved transmission of the high frequency signal. The length of such an curved area may be less than a quarter wave length of the signal transmitted in the line.

Referring to FIG. 2d, the further outer conductors 24a, 24b, 26a and 26b may, alternatively be electrically connected to the respective outer conductor 14a or 14b and to the respective slotted shield 42a or 42b via the respective vias 28a and 28b.

Referring to FIG. 3b, the waveguide 48 is spaced from the main surface of the substrate 22 by a distance d₄₈_{_{—}}₂₂ which is in a range between 0.05 to 10 μm. The distance d₄₈_{_{—}}₂₂ is defined by the main surface of the substrate 22 or a layer (e.g. an implant blocking layer, or a dielectric layer as the shallow trench isolation (STI) of a CMOS technology, or the buried oxide of a semiconductor (silicon) on insulator (SOI) technology) in/on the substrate 22 and the boundary of the lowest layer in which the slotted shield of waveguide 48 is formed, namely the layer of the pair of slotted shields 54. According to a further embodiment, an implant blocking layer 58, which may have a thickness of 0.05 μm to 5 μm, may be arranged on the substrate 22 such that the implant blocking layer 58 is arranged between the waveguide 48 and the substrate 22. According to another embodiment, inside the substrate or the implant blocked region of the substrate pieces or areas of a dielectric material as e.g. the shallow trench isolation (STI) regions of a CMOS technology, or the buried oxide of a silicon on insulator technology may be introduced. The thickness of this dielectric material may be in the range between 50 nm to 1 um.

Referring to FIG. 3c, the first inner conductor 12 and the second inner conductor 64 may, according to another embodiment, be electrically (conductive) isolated from each other, so that two signal lines are formed.

Referring to FIGS. 4a to 4c it should be noted that a transmission line with two inner conductors for two signals may be used as a directional coupler if the line length is a quarter wave length long. Further such a lines can be used for the transmission of differential signals.

Referring to FIGS. 2 to 4 it should be noted that different ground connections, e.g. a symmetric or asymmetric ground connection may be used.

Referring now to FIG. 2b, according to a first embodiment, the two outer conductor 14a and 14b are connected to ground at all four ground Ports PG01, PG02, PG03 and PG04 located in the first layer of the outer conductors 14a and 14b and inner conductor 12, i.e., the waveguide is symmetrically connected to ground.

According to a second embodiment, the waveguide may be connected to ground at the first side with the first outer conductor 14a, e.g. PG03 and at a second side with the second outer conductor 14b, e.g. PG02, or vice versa. Here, the two unconnected ground ports, e.g. PG01 and PG04, of the waveguide are floating. This second embodiment forms also a symmetric ground connection. The symmetric ground connection and especially the symmetric ground connection having two floating ground ports may be used for the waveguides 68, 72 and 82 shown in FIGS. 4a to 4c, because of the fact that the distances of the respective inner conductors 12 and 70 to the outer conductors 14a and 14b differ due to the asymmetric arrangement of the inner conductors 12 and 70. This symmetric ground connection having two floating ground ports enables to reduce the area of the device due to enhancing magnetic fields caused by the currents running in the same direction through the respective inner conductor 12 and outer conductor 14a as well as inner conductor 70 and outer conductor 14b if the inner conductors 12 and 70 are shorted at one end of the line. Such a transmission line forms an inductor or coil with a high inductance. If the ports PG01 and PG04 are connected to ground and PG03 and PG02 are left floating such a transmission line with shorted inner conductors 12 and 70 at one end forms a capacitor with a high resonance frequency due to canceling inductances in the inner and outer conductor due to currents running in the opposite direction in the inner conductor 12 and outer conductor 14a as well as inner conductor 70 and outer conductor 14b.

According to another embodiment, the two outer conductors 14a and 14b are asymmetrically connected to ground. That is, the waveguide or, in more detail, the two outer conductors 14a and 14b are connected to ground via two ground ports at a first side, e.g. with PG01 and PG02 (first side) or PG03 and PG04 (second side), while the two ground ports of the outer conductor 14a and 14b at the second side, e.g. PG03 and PG04 or PG01 and PG04, respectively, are floating. Here, the impedance of the transmission line behaves differently from which side, P01 or P02, the inner conductor 12 is driven. In other words, this forms a transmission line having outer conductors with floating ground connections on one side. For example, driving the waveguide at port P01 of the inner conductor 12 leads to more capacitive impedance behavior due compensating the magnetic fields caused by the currents through the inner conductor 12 and the outer conductors 14a and 14b. Furthermore, driving the waveguide at port P02 of the inner conductor 12 leads to more inductive impedance behavior due adding the magnetic fields caused by the currents through the inner conductor 12 and the outer conductors 14a and 14b. Such a transmission line shows a different impedance behavior from which side its excited.

A further embodiment comprises an integrated circuit comprising one of the described transmission lines with a spaced slotted shield with a line length equal or larger than 50 μm or 0.8 times a quarter wavelength of the signal transmitted in the transmission line. In a further embodiment the circuit contains a MOS transistors. In a further embodiment the circuit comprises a bipolar transistor.

Although some aspects have been described in the context of an apparatus, it is clear that these aspects also represent a description of the corresponding method for transmitting a high frequency signal, where a block or device corresponds to a method step or a feature of a method step.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

What is claimed is:

1. A waveguide comprising:
an inner conductor arranged in a first layer;
a pair of outer conductors comprising a first outer conductor and a second outer conductor; and
a pair of slotted shields comprising a first slotted shield and a second slotted shield,
wherein the first slotted shield and the second slotted shield are arranged in a second layer with a spacing in between to form a section of a ground shield,
wherein the second layer is parallel to the first layer, and
wherein the first slotted shield is connected to the first outer conductor, and wherein the second slotted shield is connected to the second outer conductor.

2. The waveguide according to claim 1, wherein the first slotted shield and the second slotted shield comprise a plurality of slots which are arranged in the second layer, and which are perpendicular to a main extension of the inner conductor within a tolerance of +/−10 degree.

3. The waveguide according to claim 1, wherein the first outer conductor and the second outer conductor and/or the first slotted shield and the second slotted shield are parallel to the inner conductor at least in an area along a main extension of the inner conductor.

4. The waveguide according to claim 1, wherein the inner conductor is straight.

5. The waveguide according to claim 1, wherein the inner conductor is curved or comprises a bend.

6. The waveguide according to claim 5, wherein the first outer conductor and the second outer conductor are electrically connected in an area where the inner conductor is curved or comprises the bend.

7. The waveguide according to claim 1, wherein the spacing extends along the inner conductor.

8. The waveguide according to claim 1, wherein the spacing is in a range between 0.1 and 5.0 times a width of the inner conductor.

9. The waveguide according to claim 8, wherein the spacing is smaller than the spacing of the first outer conductor and second outer conductor.

10. The waveguide according to claim 1, wherein the spacing is in a range between 10 nm up to a value smaller than the spacing of the first outer conductor and second outer conductor.

11. The waveguide according to claim 8, wherein the spacing is equal to the width of the inner conductor.

12. The waveguide according to claim 1, wherein the inner conductor and the pair of outer conductors are arranged in the first layer such that the inner conductor is between the first outer conductor and the second outer conductor.

13. The waveguide according to claim 1, wherein the waveguide comprises at least one further inner conductor which is arranged in the first layer and which is parallel to the inner conductor.

14. The waveguide according to claim 1, wherein the waveguide comprises a further inner conductor arranged parallel to the inner conductor, wherein the further inner conductor is arranged in a further layer which is parallel to the first layer.

15. The waveguide according to claim 1, wherein the waveguide comprises a further pair of outer conductors comprising a third outer conductor and a fourth outer conductor, wherein the further pair of outer conductors is arranged parallel to the pair of outer conductors comprising the first outer conductor and the second outer conductor, and wherein the further pair of outer conductors is arranged in a further layer which is parallel to the first layer.

16. The waveguide according to claim 1, wherein the first outer conductor is electrically connected to the first slotted shield by one or more vias and wherein the second outer conductor is electrically connected to the second slotted shield by one or more vias.

17. The waveguide according to claim 1, which comprises an additional pair of slotted shields comprising a third slotted shield and a fourth slotted shield, wherein the additional pair of slotted shields is arranged parallel to the pair of slotted shields comprising the first slotted shield and the second slotted shield, and
wherein the additional pair of slotted shields is arranged in an additional layer which is parallel to the first layer and the second layer.

18. The waveguide according to claim 17, wherein the additional layer is arranged between the first layer and the second layer.

19. The waveguide according to claim 17, wherein the first layer is arranged between the second layer and the additional layer.

20. The waveguide according to claim 17, wherein the waveguide comprises a further pair of outer conductors comprising a third outer conductor and a fourth outer conductor,
wherein the further pair of outer conductors is arranged parallel the pair of outer conductors comprising the first outer conductor and the second outer conductor, and
wherein the further pair of outer conductors is arranged in a further layer, which is arranged parallel to the first layer and the second layer and arranged between the first layer and the additional layer.

21. The waveguide according to claim 1, wherein the pair of slotted shields comprises an electrically conductive fill structure with a spacing between the first slotted shield and the fill structure and with a spacing between the second slotted shield and the fill structure
wherein the electrically conductive fill structure is arranged in the second layer and between the first slotted shield and the second slotted shield.

22. A waveguide comprising:
an inner conductor arranged in a first layer and extending along a main extension;
a pair of outer conductors comprising a first outer conductor and a second outer conductor; and
a pair of slotted shields comprising a first slotted shield and a second slotted shield,
wherein a boundary of the first outer conductor is parallel to a boundary of the inner conductor adjacent to the first outer conductor, and wherein a boundary of the second outer conductor is parallel to a boundary of the inner conductor adjacent to the second outer conductor,
wherein the first slotted shield and the second slotted shield are arranged in a second layer with a spacing in between to form a section of a ground shield, wherein the second layer is parallel to the first layer,
and wherein the spacing is in a range between 10 nm up to a value smaller than the spacing of the first and second outer conductors or in a range between 0.1 and 5.0 times the width of the inner conductor but smaller than the spacing of the first and second outer conductors,
wherein the first slotted shield is electrically connected to the first outer conductor, and wherein the second slotted shield is electrically connected to the second outer conductor,
wherein the first slotted shield and the second slotted shield comprise a plurality of slots arranged in the second layer, which are perpendicular to the main extension within a tolerance of +/−10 degrees.

23. A quarter wave length transformer comprising:
an inner conductor arranged in a first layer;
a pair of outer conductors comprising a first outer conductor and a second outer conductor; and
a pair of slotted shields comprising a first slotted shield and a second slotted shield,
wherein the first slotted shield and the second slotted shield are arranged in a second layer with a spacing in between to form a section of a ground shield,
wherein the second layer is parallel to the first layer, and
wherein the first slotted shield is connected to the first outer conductor, and wherein the second slotted shield is connected to the second outer conductor.

24. A method for transmitting a high frequency signal by use of a waveguide, the method comprising:
exciting an electromagnetic wave in a waveguide, which comprises an inner conductor, a pair of outer conductors, a pair of slotted shields with a spacing in between and a medium within the waveguide, such that a phase velocity or group velocity of the electromagnetic wave in the waveguide is smaller than, at least by a factor of 5/4, a phase velocity or group velocity of the electromagnetic wave in the medium.
